(19) United States
(12) Patent Application Publication
(10) Pub. No.: US 2005/0226703 A1
(43) Pub. Date: Oct. 13, 2005

(54) Robot arm having an integrated drive device

(76) Inventors: Georgios Konstas, Kantza (GR); Konstantin Buscher, Igersheim (DE)

Correspondence Address: BACHMAN & LAPOINTE, P.C., 900 CHAPEL STREET, SUITE 1201, NEW HAVEN, CT, 06510, US

(21) Appl. No.: 10/510,665

(22) PCT Filed: Jan. 22, 2003
(86) PCT No.: PCT/EP03/00572

§ 371 Date: May 16, 2005

(30) Foreign Application Priority Data
Apr. 12, 2002 (DE) 10216435.5

(51) Int. Cl. B25J 1/00

(52) U.S. Cl. 414/222.07

(57) ABSTRACT

A robot arm comprises an integrated drive device for a robot (R) and is operatively connected to a main drive via at least one arm. The robot arm comprises a number of drive motors (M₁ to M₃) for rotating the robot arm housing and for driving a quill.

### BACKGROUND OF THE INVENTION

The present invention relates to a drive device for a robot arm for a robot which is connected to a main drive via at least one arm such that it can be moved, the robot arm having a housing and a plurality of drive motors being provided in order to swivel the housing about and axis and in order to drive a spindle in rotation about an axis and linearly along the axis.

Drive devices of this type are known and can be obtained on the market in many forms and designs. The disadvantage is that these are all of very complicated construction in terms of apparatus and drive motors for moving these drive devices for robots are normally situated on said drive devices, that is to say can be connected to one another by diverse coupling elements and are implemented in a separate housing.

It is, moreover, disadvantageous that drive devices of this kind are very complicated to produce and, in particular, are not suitable for very small robots, mini robots.

EP 0 295 306 A1 discloses a robot arm, individual arms being connected to one another such that they can be swiveled, and it being possible for the individual arms to be braked by separate braking devices. The individual arms are swiveled into one another via separate individual electric motors.

A similar construction of robot arms is disclosed by U.S. Pat. No. 5,017,083, in which an electric motor for swiveling the individual robot arm is seated on the individual robot arm. The electric motors are placed and driven independently on the arms.

A similar robot arm is described in U.S. Pat. No. 5,271,292. There, individual separate motors are also seated on a robot arm in order to swivel the respective arms with one another or toward one another.

U.S. Pat. No. 6,287,406 B1 shows a parallelogram-like removable system for glass roofs, appropriate individual motors which can be driven separately being assigned to each arm or arm elements.

The present invention is based on the object of providing a drive device of the type mentioned at the beginning which eliminates the aforementioned disadvantages and with which a drive unit, in particular a robot arm for robots, can be implemented which is of very small construction and can be used universally. Furthermore, it should be possible to implement very large angles, in particular swiveling angles and very high power and power densities.

### SUMMARY OF THE INVENTION

In order to achieve the object, the drive motors are inserted into the housing in an integrated manner and motor shafts of the drive motors are mounted in the housing of the robot arm, the spindle and also the drive motors being inserted into the common housing of the robot arm and stators of the drive motors being inserted into receiving openings in a fixedly integrated or re-detachable manner.

In the present invention, it has proven to be particularly advantageous to integrate a plurality of drive motors permanently in housing, in particular in the robot arm, in order firstly to swivel the robot arm and secondly to drive a spindle in rotation and, at the same time, to permit a linear lifting movement of the spindle.

In this case, the motor elements can, for example, be permanently inserted into a corresponding receiving opening in the housing or mounted therein. In particular, thought may also be given for example to the respective mountings of the motor shaft being carried out in bearing plates which are accommodated in the housing.

In this way, the spindle rods and/or the shafts of the drive motors can be inserted into the housing in an integrated and cost-saving manner. Likewise, a transmitter element can be connected to one and the same shaft of the motor element, as a feedback instrument, absolute value transmitter, encoder, resolver or the like.

In addition, the appropriate mounting of the motor element is situated directly in the housing or is integrated into the housing. This ensures that the motor elements are formed as constituent parts of the housing itself, in order to swivel the robot arm and/or drive the spindle in rotation or linearly.

In this way, corresponding belts, toothed belts, toothed disks or the like can be provided in order to carry out the corresponding drive movements. The invention is not to be restricted to this.

### BRIEF DESCRIPTION OF THE DRAWINGS

Further advantages, features and details of the invention emerge from the following description of preferred exemplary embodiments and by using the drawing, in which:

FIG. 1 shows a perspectively illustrated view of a drive device, in particular a robot arm for a robot;

FIG. 2 shows a schematically illustrated bottom view of a housing of the robot arm;

FIG. 3 shows a partially perspectively illustrated top view of the robot arm according to FIG. 1;

FIG. 4 shows a schematically illustrated perspective bottom view of part of the robot arm according to FIG. 1.

### DETAILED DESCRIPTION

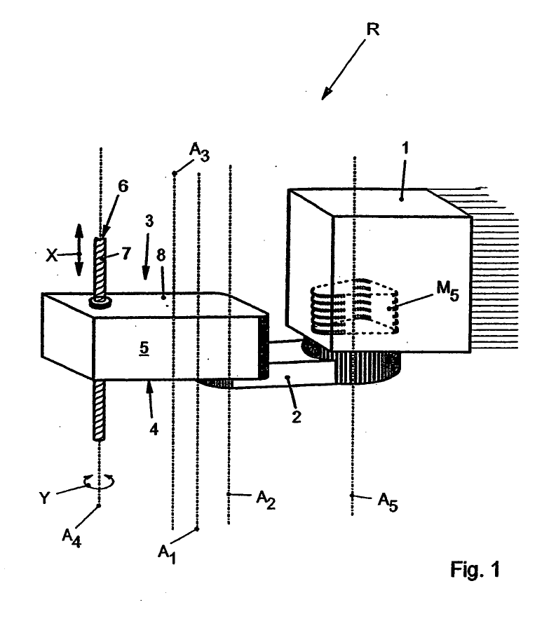

According to FIG. 1, a robot R has a main drive 1 which can be fixed to or mounted on a frame, machine frame or the like, not illustrated here, such that it can be displaced vertically and/or laterally, if appropriate.

Preferably integrated in the main drive 1 is a drive motor M₅, in order to drive an arm 2 such that it can be swiveled in a controlled manner about the axis A₅.

The actual drive unit 3 is situated such that it can be swiveled about an axis A₂ of the arm 2.

The drive unit 3 is formed as a robot arm 4 and has a housing 5 in which, at one end, a linear guide, in particular a spindle 6, preferably constructed as a threaded rod, in particular a recirculating-ball spindle 7, can be moved in the illustrated direction of the double arrow X and can be driven to and fro about the axis 4 in the illustrated direction of the double arrow Y.

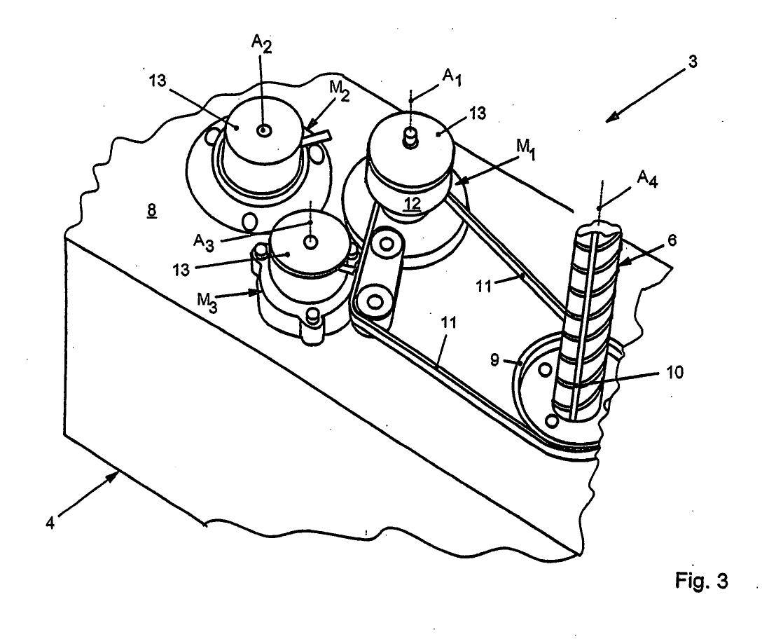

Provided in the region of an upper side 8 of the robot arm 4, as also emerges in particular from FIG. 3, is a drive disk 9 or the like, pin elements or similar dogs, not illustrated here, engaging in a groove 10 in the spindle 6 in order to drive the latter in rotation about the axis A₄. In this case, the drive movement of the drive disk 9 is carried out via a belt element 11, which is driven by the drive motor M₁. Seated on the latter are a braking device 12. and a transmitter element 13.

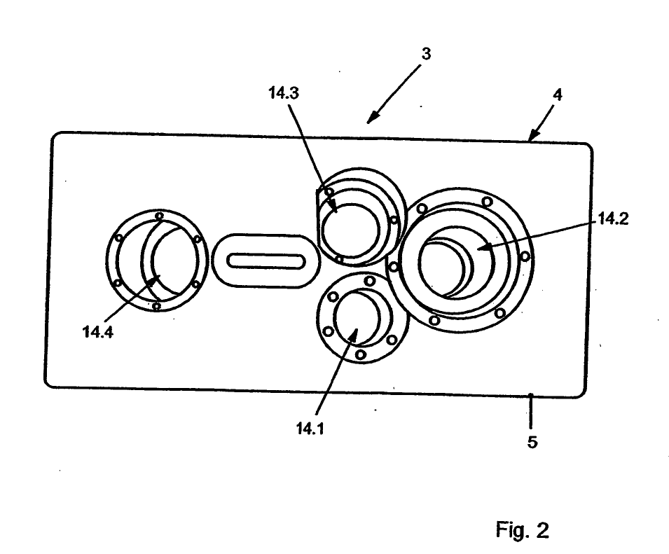

In the present invention, as illustrated in particular schematically in FIG. 2, it is important that receiving openings 14.1 to 14.4 are provided in the housing 5 of the robot arm 4, the spindle 6 being inserted into the receiving opening 14.4, the drive motor M₁ being inserted into the receiving opening 14.1 and the drive motors M₂ and M₃ being inserted into the respective receiving openings 14.2, 14.3 in a fixed, preferably re-detachable, manner. In this case, all the drive motors M₁ to M₃ required for the movement of the spindle 6 and for the movement of the robot arm 3 are inserted into the housing 5 of the robot arm 4 in an integrated manner. Their motor shafts are also seated directly in mountings as a constituent part of the housing 5.

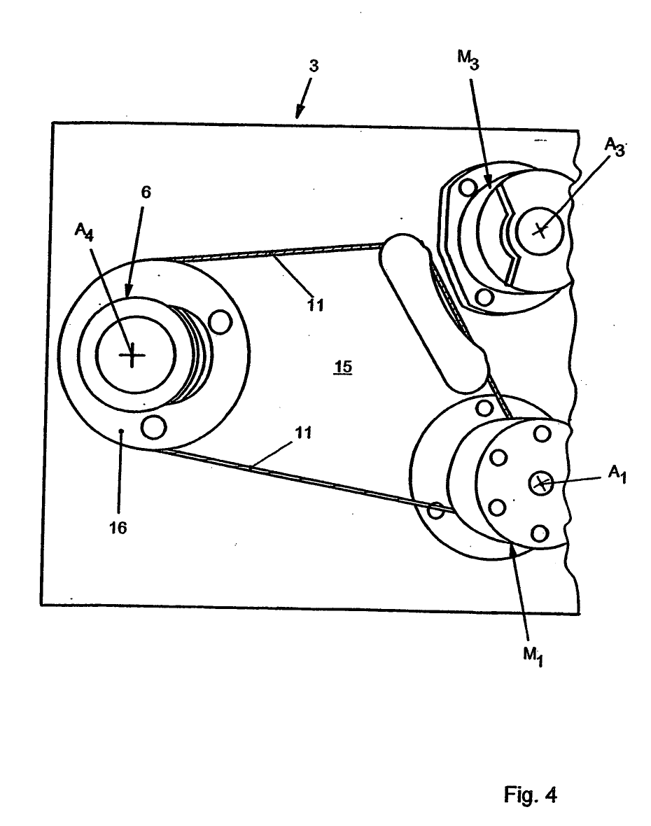

In order to carry out the lifting movement of the spindle 6, as illustrated in particular in FIG. 4, a lifting disk 16 is mounted on an underside 15 via bearings, not illustrated here, such that it can be rotated radially, corresponding ball elements or the like, not illustrated here, engaging in the spindle 6 and, as a result of rotation of the lifting disk 16, it being possible for the spindle 6 to be moved to and fro in the illustrated direction of the double arrow X, see FIG. 1.

In this case, the lifting disk 16 is driven by means of the drive motor R₁ via the transmission element, in particular belt element 11, or implemented as a chain element.

The drive motor M₂, which is integrated in the housing 5 of the robot arm 4, is used for the active driving and swiveling of the robot arm 4 with respect to the arm 2 about the axis A₂.

1. A drive device for a robot arm (4) for a robot (R) which is connected to a main drive (1) via at least one arm (2) such that it can be moved, wherein the robot arm (4) has a plurality of drive motors (M₁ to M₃) for swiveling a housing (5) and, optionally, for driving a spindle (6).

2. The drive device as claimed in claim 1, wherein the drive motors (M₁ to M₃) are inserted into the housing (5) in an integrated manner.

3. The drive device as claimed in claim 2, wherein the drive motors (M₁ to M₃) are integrated in receiving openings (14.1 to 14.3) of the housing 5 and are optionally designed as a shrunk or releasable connection.

4. The drive device as claimed in claim 1, wherein each drive motor (M₁ to M₃) is assigned a transmitter element (13), in particular a resolver, encoder or absolute value transmitter.

5. The drive device as claimed in claim 1, wherein an electromagnetically operated braking device (12) is assigned to the drive motor (M₁).

6. The drive device as claimed in claim 1, wherein the housing (5), in particular the robot arm (4), is connected to the arm (2) such that it can be swiveled about an axis (A₂), the drive motor (M₂) controlling a swiveling movement of the robot arm (4) with respect to the arm (2).

7. The drive device as claimed in claim 6, wherein in each case the two drive motors (M₁ and M₃) are arranged close by in the region of the drive motor (M₂).

8. The drive device as claimed in claim 1, wherein a drive disk (9) of a linear guide, in particular the spindle (6), is driven by the drive motor (M₁) by means of a transmission element.

9. The drive device as claimed in claim 8, wherein the spindle (6) is constructed as a threaded spindle, recirculating-ball spindle (7) having a groove (10) running in a longitudinal direction.

10. The drive device as claimed in claim 9, wherein the drive disk (9) engages in the groove (10) and, by means of being driven in rotation by the drive motor (M₁), permits a rotational movement of the spindle (6) about an axis (A₄).

11. The drive device as claimed in claim 1, wherein, in order to carry out a lifting movement, a lifting disk (16) engages with the drive motor (M₃) via a transmission element, at least one element engaging in spindle-like recesses in the spindle (6) in order to carry out a lifting movement as a result of rotation of the lifting disk (16).

12. The drive device as claimed in claim 1, wherein the drive motors (M₁ to M₄) are inserted into the housing (5) of the robot arm (4) in an integrated manner.

13. The drive device as claimed in claim 1, wherein the main drive (1) has a drive motor (M₅) which drives the arm (2) about an axis (A₅).

14. The drive device as claimed in claim 1, wherein motor shafts of the drive motors (M₁ to M₃) are mounted in the housing 5.

15. The drive device as claimed in claim 1, wherein stators of the drive motors (M₁ to M₃) are inserted into the receiving openings 14.1 to 14.3 in a fixed manner.

16. A robot comprises a main drive connected to an arm for driving the arm about an axis A₅; a robot arm connected to the arm, the robot arm comprises a housing and a spindle mounted in the housing; and drive means for driving the housing at least about an axis A₂ of the arm and the spindle about an axis A₄ of the robot arm, the drive means comprises a plurality of drive motors.

17. The robot as claimed in claim 16, wherein the drive motors are inserted into the housing (5) in an integrated manner.

18. The robot as claimed in claim 1 or 2, wherein the drive motors (M₁ to M₃) are integrated in receiving openings of the housing 5 by a releasable connection.

19. The robot as claimed in claim 16, wherein each drive motor is assigned a transmitter element comprising at least one of a resolver, encoder and absolute value transmitter.

20. The robot as claimed in claim 16, wherein an electromagnetically operated braking device (12) is assigned to at least one of the drive motors.

21. The robot as claimed in claim 16, wherein the housing is connected to the arm (2) such that it can be swiveled about the axis A₂ by one of the drive motors M₂.

22. The robot as claimed in claim 21, wherein two further drive motors M₁ and M₃ are arranged in the region of the drive motor M₂.

23. The robot as claimed in claim 22, wherein a drive disk for the particular spindle is driven by the drive motor M₁ by means of a transmission element.

24. The robot as claimed in claim 16, wherein the spindle is constructed as a threaded, recirculating-ball spindle having a groove running in a longitudinal direction.

25. The robot as claimed in claim 24, wherein a drive disk engages in the groove and, by means of being driven in rotation by the drive motor M₁, permits a rotational movement of the spindle about the axis A₄.

26. The robot as claimed in claim 22, wherein, in order to carry out a lifting movement, a lifting disk engages with the drive motor (M₃) via a transmission element and at least one element engages in spindle-like recesses in the spindle to carry out a lifting movement as a result of rotation of the lifting disk.

27. The robot as claimed in claim 16, wherein the drive motors are inserted into the housing of the robot arm in an integrated manner.

28. The robot as claimed in claim 16, wherein the main drive has a drive motor M₅ which drives the arm about the axis A₅.

29. The robot as claimed in claim 22, wherein motor shafts of the drive motors M₁ to M₃ are mounted in the housing.

30. The robot as claimed in claim 18, wherein stators of the drive motors M₁ to M₃ are inserted into the receiving openings in a re-detachable manner.
